(19) United States
(12) Patent Application Publication
(10) Pub. No.: US 2014/0317704 A1
(43) Pub. Date: Oct. 23, 2014

(54) METHOD AND SYSTEM FOR ENABLING THE FEDERATION OF UNRELATED APPLICATIONS

(71) Applicant: OpenPeak Inc., Boca Raton, FL (US)

(72) Inventors: Philip Schentrup, Parkland, FL (US); Andrew James Dobson, Wellington, FL (US); Robert M. Dare, Sunrise, FL (US); Christopher Michael Wade, Delray Beach, FL (US)

(21) Appl. No.: 14/205,510

(22) Filed: Mar. 12, 2014

Related U.S. Application Data
(60) Provisional application No. 61/792,727, filed on Mar. 15, 2013.

(51) Int. Cl. H04L 29/06

(52) U.S. Cl. CPC H04L 63/0815
USPC 726/6

(57) ABSTRACT

A method of enabling the federation of unrelated applications is described herein. The method can include the step of installing a candidate application for inclusion in a secure workspace. A first previously-installed application may have a certificate signed by a first entity, and a second previously-installed application may have a certificate signed by a second entity such that the first and second previously-installed applications have different certificates. The method can also include the steps of generating a federation value for the candidate application for inclusion in the secure workspace and determining the result of a federation check of the candidate application based on the generated federation value. If the federation check for the candidate application is satisfied, the candidate application may be permitted to be part of the secure workspace.

### CROSS-REFERENCE TO RELATED APPLICATIONS

This patent application claims priority to U.S. Provisional Patent Application No. 61/792,727, filed on Mar. 15, 2013, which is incorporated herein by reference in its entirety.

### FIELD OF TECHNOLOGY

The present description relates to systems and methods for enabling the federation of applications and in particular, the federation of applications that are unrelated.

### BACKGROUND

Many mobile devices have the ability to download and install applications, or apps, to increase their usefulness. Most of the apps that are installed on these devices are available at electronic storefronts known colloquially as app stores. To foster the sale of mobile communication devices and apps, the operators of the app stores have made it easy for app developers to upload their apps to the app stores. As such, there are a tremendous number of apps available from a litany of app developers at these app stores, many of which are attached to certificates that are signed by different entities.

Because the apps may come from so many different sources, the security of the mobile devices, as well as the apps themselves, is an important issue. Thus, it may seem natural to restrict interprocess communications between apps on a mobile device, particularly those with certificates signed by different parties. While useful for security, however, such a configuration limits the functionality and efficiency of the apps. The conflict becomes even more magnified when a secure workspace—a protected environment on the mobile device that contains apps that may have access to an enterprise's sensitive data—is generated on the mobile device.

### SUMMARY

A method of enabling the federation of unrelated applications is described herein. The method can include the step of installing a candidate application for inclusion in a secure workspace. A first previously-installed application in the secure workspace has a certificate signed by a first entity, and a second previously-installed application in the secure workspace has a certificate signed by a second entity such that the first and second previously-installed applications have different certificates. The method can also include the steps of generating a federation value for the candidate application installed for inclusion in the secure workspace and determining the result of a federation check of the candidate application based on the generated federation value. If the federation check for the candidate application is satisfied, the candidate application may be permitted to be part of the secure workspace.

The method can also include the step of preventing the candidate application from being part of the secure workspace if the federation check for the candidate application is not satisfied. For example, preventing the candidate application from being part of the secure workspace includes deleting the candidate application, deleting any data associated with or generated by the candidate application or reporting such deletions to a remote location. The method can also include the step of transmitting the federation value to a remote location to enable the federation check to be performed at the remote location.

In one arrangement, as part of the federation check, the generated federation value can be compared to a known federation value. In addition, comparing the generated federation value to the known federation value may be performed locally, such as on a computing device that includes the secure workspace that the candidate application is attempting to join. As an example, the federation value is a hash based on at least some of the code of the candidate application. The hash, as another example, is further based on an identification name and version code of the candidate application. The federation value can be generated at the time when a candidate application is installed or when the candidate application is launched.

The method can also include the steps of determining the result of a domain restriction check of the candidate application and permitting the candidate application to be part of the secure workspace if both the federation check and the domain restriction check of the candidate application are satisfied. A device identification can be sent to a remote location, such as an administrative facility or some other back-end service, to facilitate the domain restriction check.

In one arrangement, the method can also include the step of generating a local federation list that includes information related to applications that have satisfied the federation check and have been permitted to be part of the secure workspace. In addition, communications between applications with different certificates may be permitted if one or more of the applications satisfy a check with the local federation list.

Another method of enabling the federation of unrelated applications is described herein. The method can include the steps of receiving a reference federation value associated with an application and storing the reference federation value. When the application is installed on a computing device or some time after the installation of the application on the computing device, a generated federation value may be received from the computing device. A federation check can be conducted that at least includes comparing the generated federation value to the reference federation value. The method also may include the step of generating a federation approval signal to be delivered to the computing device that authorizes the application to be part of a secure workspace on the computing device if the federation check is satisfied. The approval signal can include an explicit approval to permit the application to be part of the secure workspace, or it can simply be an implicit approval that can include information that may be processed by another component to determine that the application may be so permitted. In fact, any type of approval or disapproval signal described herein may be an explicit or implicit signal.

The method can also include the step of generating a federation disapproval signal to be delivered to the computing device that prevents the application from being part of the secure workspace on the computing device if the federation check is not satisfied. The method can also include the step of receiving a notification that the application was removed from the computing device in response to the receipt of the federation disapproval signal at the computing device. As an example, the reference federation value and the generated federation value may be hash values based on at least some portion of the application.

In another arrangement, the method can include the steps of receiving a device identification from the computing device and conducting a domain restriction check to determine whether the application is permitted to operate in the domain of the computing device. A domain restriction approval signal can be generated if the domain restriction check is satisfied or a domain restriction disapproval signal can be generated if the domain restriction check is not satisfied. The domain restriction disapproval signal can be generated if the domain restriction check is not satisfied even if the federation check of the application is satisfied.

Another method of enabling the federation of unrelated applications is described herein. The method can include the steps of receiving at a remote location reference federation values associated with a plurality of applications having different certificates and storing the reference federation values at the remote location. The method can also include the step of installing at least one of the applications on a computing device, generating a federation value for the installed application and transmitting the generated federation value to the remote location. A federation check may be performed at the remote location by comparing the generated federation value to the reference federation value that is associated with the installed application. If the federation check is satisfied, a federation approval signal can be generated to be delivered to the computing device. In response to the receipt of the federation approval signal, the installed application may be permitted to be part of a secure workspace of the computing device.

If the federation check is not satisfied, a federation disapproval signal can be generated to be delivered to the computing device. In response to the receipt of the federation disapproval signal, the application can be prevented from being part of the secure workspace of the computing device. Preventing the application from being part of the secure workspace may include deleting the application, deleting any data associated with or generated by the application or reporting the deletion to the remote location. As an example, the reference federation values and the generated federation value may be hashes based on at least part of the executable code of the applications.

The method may also include the step of performing a domain restriction check at the remote location to determine whether the installed application is in an authorized domain. A domain restriction approval signal may be generated if the domain restriction check is satisfied such that the installed application is in an authorized domain. Alternatively, a domain restriction disapproval signal may be generated if the domain restriction check is not satisfied such that the installed application is outside an authorized domain.

Another method of enabling the federation of unrelated applications is described herein. The method can include the steps of receiving unrelated target applications in which the unrelated target applications are attached to certificates that are signed by different entities and modifying the unrelated target applications to create secure unrelated applications for possible installation in a secure workspace. The method can also include the step of generating reference federation values for the unrelated secure applications. Modifying the unrelated target applications may include configuring the unrelated secure applications to generate installation federation values for comparison with the reference federation values to determine whether the unrelated secure applications are permitted to be installed in the secure workspace.

As an example, the reference federation values and the installation federation values may be hashes that are based on at least a portion of the unrelated secure applications. The hashes may also be based on identifications and version codes of the unrelated secure applications.

In one arrangement, modifying the unrelated target applications may further include configuring the unrelated secure applications to generate the installation federation values at the time the unrelated secure applications are installed on a computing device or at the time the unrelated secure applications are launched on the computing device. In another embodiment, modifying the unrelated target applications may further include configuring the unrelated secure applications to provide domain restriction information for the purpose of determining whether the unrelated secure applications are part of an authorized domain.

A computing device is described herein. The computing device can include a display that is configured to display a plurality of installed applications that are part of a secure workspace and memory that is configured to store the installed applications. The computing device may also have a processing unit that is communicatively coupled to the display and the memory. The processing unit may be configured to direct the installation of the applications in which the applications are unrelated applications such that at least some of the applications have certificates that are signed by different entities. The processing unit may also be configured to generate a federation value for an application that is to be part of the secure workspace and to determine the result of a federation check of the application based on the generated federation value. The processing unit may also be configured to permit the application to be part of the secure workspace if the federation check is satisfied.

The processing unit may be further configured to prevent the application from being part of the secure workspace if the federation check is not satisfied. The computing device may also include an interface that is communicatively coupled to the processing unit and that is configured to transmit the generated federation value to a remote location, where the generated federation value is compared to a reference federation value.

In one arrangement, the processing unit can be further configured to generate the federation value at the time the application is installed or at the time the application is launched. As an example, the application can be a secure application that has been modified by binding one or more intercepts into the application.

The processing unit can be further configured to determine the result of a domain restriction check of the application that is to be part of the secure workspace and to permit the application to be part of the secure workspace if both the federation and domain restriction checks are satisfied. The processing unit can be further configured to generate a local federation list that may identify the applications that have been permitted to be part of the secure workspace. The processing unit can be further configured to facilitate communications between unrelated applications that are part of the secure workspace if one or more of the unrelated applications satisfy a check of the local federation list.

An administrative facility is also described herein. The facility can include an interface that is configured to facilitate communication exchanges with a plurality of computing devices, memory for storing information related to the computing devices and a processing unit that is communicatively coupled to the interface and the memory. The processing unit can be configured to receive from the interface a reference federation value of an application, store the reference federation value into the memory and receive from the interface a generated federation value of the application when the application is attempting to federate in a secure workspace of a computing device. The processing unit can be further configured to—in response—conduct a federation check by comparing the generated federation value to the stored reference federation value and to generate a federation approval signal to be delivered to the computing device that authorizes the application to be part of the secure workspace if the federation check is satisfied.

As an example, the federation check is satisfied if the generated federation value matches the reference federation value. As another example, the reference federation value and the generated federation value may be hashes based on at least a portion of the application. The application can be, for example, a secure application.

The processing unit is further configured to conduct a domain restriction check to determine whether the application is permitted to operate in the domain of the computing device. If the domain restriction check is not satisfied, the processing unit can be further configured to generate a domain restriction disapproval signal that is designed to prevent the application from becoming part of the secure workspace, even if the federation check is satisfied.

An administrative facility for facilitating the federation of unrelated applications is also described herein. The facility may include an interface that is configured to receive unrelated target applications in which the unrelated target applications are attached to certificates that are signed by different entities. The facility can also include a processing unit that can be communicatively coupled to the interface. The processing unit can be configured to modify the unrelated target applications to create secure unrelated applications for possible installation in a secure workspace and to generate reference federation values for the unrelated secure applications. Modifying the unrelated target applications may include configuring the unrelated secure applications to generate installation federation values for comparison with the reference federation values to determine whether the unrelated secure applications are permitted to be installed in the secure workspace. As an example, the interface is further configured to transmit the reference federation values to a remote location for storage.

A non-transitory computer readable storage medium is also described herein. The non-transitory computer readable storage medium can include instructions that cause a computing device to take certain actions relating to the federation of unrelated applications when the storage medium is loaded or installed on the computing device. For example, the instructions of the storage medium can cause the computing device to install a candidate application for inclusion in a secure workspace. A first previously-installed application in the secure workspace has a certificate signed by a first entity, and a second previously-installed application in the secure workspace has a certificate signed by a second entity such that the first and second previously-installed applications have different certificates. The instructions of the storage medium can also cause the computing device to generate a federation value for the candidate application installed for inclusion in the secure workspace and determine the result of a federation check of the candidate application based on the generated federation value. If the federation check for the candidate application is satisfied, the candidate application may be permitted to be part of the secure workspace.

Further features and advantage, as well as the structure and operation of various embodiments, are described in detail below with reference to the accompanying drawings. It is noted that this description is not limited to the specific embodiments presented herein. Such embodiments are provided for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the subject matter described herein and, together with the description, further serve to explain the principles of such subject matter and to enable a person skilled in the relevant art(s) to make and use the subject matter.

FIG. 1 illustrates an example of a system for enabling the federation of unrelated applications.

FIG. 2 illustrates exemplary block diagrams of some of the components of FIG. 1.

FIG. 3 illustrates an example of a representation of a secure workspace.

FIG. 4 illustrates an example of a method for creating secure applications through an adaption process.

FIG. 5 illustrates an example of a method for enabling the federation of unrelated applications.

FIG. 6 illustrates an example of a supplemental check to the method of FIG. 5.

FIG. 7 illustrates an example of an adaption process.

Applicants expressly disclaim any rights to any third-party trademarks or copyrighted images included in the figures. Such marks and images have been included for illustrative purposes only and constitute the sole property of their respective owners.

The features and advantages of the embodiments herein will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The following detailed description refers to the accompanying drawings that illustrate exemplary embodiments; however, the scope of the present claims is not limited to these embodiments. Thus, embodiments beyond those shown in the accompanying drawings, such as modified versions of the illustrated embodiments, may nevertheless be encompassed by the present claims.

References in the specification to “one embodiment,” “an embodiment,” “an example embodiment,” “one arrangement,” “an arrangement” or the like, indicate that the embodiment or arrangement described may include a particular feature, structure, or characteristic, but every embodiment may not necessarily include the particular feature, structure, or characteristic. Moreover, such phrases are not necessarily referring to the same embodiment or arrangement. Furthermore, when a particular feature, structure, or characteristic is described in connection with an embodiment or arrangement, it is submitted that it is within the knowledge of one skilled in the art to implement such feature, structure, or characteristic in connection with other embodiments or arrangements whether or not explicitly described.

Several definitions that apply throughout this document will now be presented. The term “exemplary” as used herein is defined as an example or an instance of an object, apparatus, system, entity, composition, method, step or process. The term “communicatively coupled” is defined as a state in which two or more components are connected such that communication signals are able to be exchanged between the components on a unidirectional or bidirectional (or multi-directional) manner, either wirelessly, through a wired connection or a combination of both. A “computing device” is defined as a component that is configured to perform some process or function for a user and includes both mobile and non-mobile devices. The terms “non-transitory computer program storage medium” and “non-transitory computer readable storage medium” are defined as one or more components that are configured to store instructions that are to be executed by a processing unit.

An “application” is defined as a program or programs that perform one or more particular tasks on a computing device. Examples of an application include programs that may present a user interface for interaction with a user or that may run in the background of an operating environment and that may not present a user interface while in the background. The term “secure application” is defined as an application that has been modified from its conventional form to restrict communication between the application and unauthorized programs or devices, restrict operation of the application based on policy or to alter, augment or add features associated with the operation of the application. The term “operating system” is defined as a collection of software components that directs a computing device's operations, including controlling and scheduling the execution of other programs and managing storage, input/output and communication resources. A “processing unit” is defined as one or more components that execute sets of instructions, and the components may be disparate parts or part of a whole unit and may not necessarily be located in the same physical location. The term “memory” or “memory element” is defined as one or more components that are configured to store data, either on a temporary or persistent basis. An “interface” is defined as a component or a group of components that enable(s) a device to communicate with one or more different devices, whether through hard-wired connections, wireless connections or a combination of both. A “transceiver” is defined as a component or a group of components that transmit signals, receive signals or transmit and receive signals, whether wirelessly or through a hard-wired connection or both.

The term “secure workspace” is defined as any environment of one or more secure applications that have been modified to enable interprocess communications between the secure applications but to prevent unauthorized applications or other programs from interacting with the secure applications. A “certificate” is defined as an electronic document that is used to identify the entity associated with the content attached to the certificate. A “domain” is defined as an exclusive collection of any number of discrete units that are associated and identified with (or as) an entity.

As explained earlier, most mobile devices have the ability to download and install applications, and there is a need to enable interactions among them. These applications, however, are created from many different developers, and there is a competing interest in ensuring the integrity of the mobile device and the applications themselves.

To address these issues, a method and system of enabling the federation of unrelated applications are described herein. The method can include the step of installing a candidate application for inclusion in a secure workspace. A first previously-installed application of the secure workspace may have a certificate signed by a first entity, and a second previously-installed application of the secure workspace may have a certificate signed by a second entity such that the first and second previously-installed applications have different certificates. The method can also include the steps of generating a federation value for the candidate application for inclusion in the secure workspace and determining the result of a federation check of the candidate application based on the generated federation value. If the federation check for the candidate application is satisfied, the candidate application can be permitted to be part of the secure workspace.

As such, the method and system enable applications having different certificates to become part of a secure workspace, while—through the federation check—ensuring the integrity of the applications and the computing device that are involved. Moreover, minimal effort is required to implement such a system into the computing device.

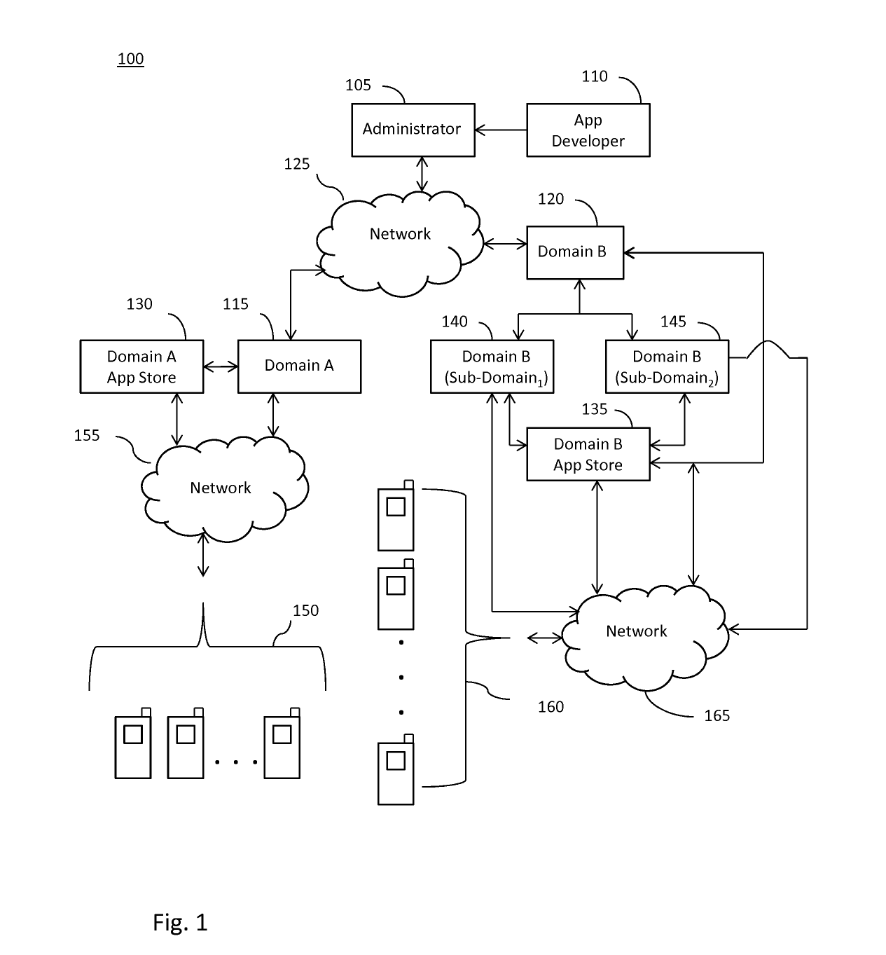

Referring to FIG. 1, an example of system 100 that enables the federation of unrelated applications is shown. In one arrangement, the system 100 can include an administrative facility 105 and an application developer portal 110, which can be communicatively coupled to one another. The administrative facility 105 can include any suitable combination of components for receiving applications from the application developer portal 110, for modifying the applications and for overseeing the distribution of the applications to one or more suitable parties. The facility 105 may also include any suitable combination of components to oversee the management of a plurality of computing devices, such as mobile units. In addition, the portal 110 may include any suitable combination of components to allow an application developer to submit applications to the facility 105.

One or more domains 115, 120 may also be part of the system 100, and may be communicatively coupled to the administrative facility 105 through the network 125. The network 125 may be any combination and type of networks to facilitate such communications. Although two domains 115, 120 are shown here, the system 100 can be configured to support any suitable number of domains. The domains 115, 120 shown here can represent any number and type of components that support/facilitate communications related to an entity, like an enterprise or an organization. For example, domain A 115 may represent the communications and data exchange and management structure of a first enterprise, while domain B 120 may represent that of a second enterprise. In one particular (but non-limiting) example, domain A 115 may correspond to an enterprise involved in computer sales in which the enterprise manages or oversees a plurality of computing devices 150 that have been provided to or belong to associates of the enterprise. The computing devices 150 may be considered restricted to domain A 115, meaning that only computing devices that have been provisioned with certain software related to the domain A 115 may be permitted to operate within and be managed by domain A 115. Such computing devices 150 may be referred to as domain computing devices, or simply domain devices. Of course, other devices may be permitted to operate within and be managed by domain A 115, such as those devices that may not have a connection with domain A 115, as the system 100 does not necessarily have to be this restrictive.

As part of its ecosystem, domain A 115 may provide a domain A application store 130. In one arrangement, access to the application store 130 or at least portions of it may be limited to the domain computing devices 150, although the application store 130 (or portions thereof) may be accessible by non-domain devices and may be open to the public or other broad groups of individuals. In either arrangement, the computing devices 150 may be communicatively coupled to the domain A 115 and the application store 130 through the network 155, which may be made up of any suitable collection of components to facilitate such communications. For example, the network 155 may actually be comprised of multiple networks.

A similar arrangement may be realized for domain B 120. Like domain A 115 and as noted earlier, domain B 120 may represent the communications and data exchange and management structure of a second enterprise. Here, however, domain B 120 may be comprised of several other nodes, such as domain B 140 and domain B 145, which may be respectively referred to as sub-domain 1 and sub-domain 2. As an example, domain B 140 and domain B 145 may be subsidiaries, divisions or other enterprises associated with the second enterprise represented by domain B 120. In one particular (but non-limiting) example, domain B 120 may be a conglomerate financial organization, and domain B 140 and domain B 145 may be separate divisions of the financial organization.

In this case, domain B 120 may have a plurality of domain computing devices 160 associated with it, while domain B 140 and domain B 145 may also have domain computing devices 160 assigned to them. The domain computing devices 160 may be communicatively coupled to their respective domains through a network 165, which can include any suitable number and type of component to facilitate such communications. Although a single network representation is shown here for simplicity, those skilled in the art will appreciate that the network 165 may comprise any suitable number and type of networks, as well, even if the networks are operated or managed by different entities. In one embodiment, the domain devices 160 associated with domain B 140 and domain B 145 may operate within and be managed by domain B 120, but the domain devices 160 of domain B 140 may not necessarily be permitted to operate within and be managed by domain B 145 (and vice-versa). Moreover, domain computing devices 160 may not necessarily be permitted to operate within and be managed by domain A 115 (or any existing sub-domains in that environment).

In view of this description, a certain hierarchical enforcement structure may be imposed on the domains, and this arrangement may apply to all or certain types of content or configurations associated with the domains. This hierarchical enforcement may be referred to as a top-down enforcement scheme such that domains at the top of a particular grouping (e.g., domain B 120) may have oversight over the domains (or sub-domains) below (e.g., domains B 140, 145). For example, domain B 120 may have management rights over the domain devices 160 that are assigned to domains B 140, 145 and may permit these domain devices 160 to operate within domain B 120. Moreover, domain B 120 may be responsible for determining—or at least have oversight of—the policies that are enforced against its domain devices 160 and those of domains B 140, 145. In this arrangement, domain B 120 may also determine or at least guide the type of content, including applications, that is installed on its domain devices 160 and those of domains B 140, 145. A domain that has such rights over lower-positioned domains (or sub-domains) may be referred to as a management domain.

In one arrangement, a single domain B application store 135 may be provided for this structure, meaning that the domain computing devices 160 associated with either of the domains B 120, 140, 145 may access content from the application store 135. In keeping with the top-down enforcement scheme described above, domain B 120 may determine the content that is to be offered by the application store 135. In another arrangement, any combination of application stores may be employed here with a connection with any suitable number of domains. For example, if desired, each of domains B 120, 140 145 may provide an application store for its domain devices 160 with the respective domain B 120, 140, 145 (or a management domain) determining the type of content offered thereby.

Other entities may operate like a management domain in this system 100. For example, the administrative facility 105 may have some control over the management of domain computing devices 150, 160 within the system 100. Moreover, the administrative facility 105 may determine the type of content that is published at any of the application stores that are within the system 100. Additional details of the management of computing devices and the delivery of content to application stores in this type of an arrangement are presented in U.S. patent application Ser. No. 13/179,513, filed on Jul. 9, 2011, which is incorporated by reference herein in its entirety.

In view of the large number of applications that may be available for download to a domain computing device 150, 160, an enterprise may wish to take precautions to ensure that its data that may be installed on or accessed by the devices 150, 160 is secure. For example, a secure workspace may be integrated into these devices 150, 160, and secure applications may be part of the secure workspace. A user may have to provide some type of credentials to be given access to the secure workspace or to secure applications that are part of the secure workspace. In another embodiment, the administrative facility 105 may be responsible for providing or managing the offering of secure applications. One example of how secure applications may be developed will now be presented.

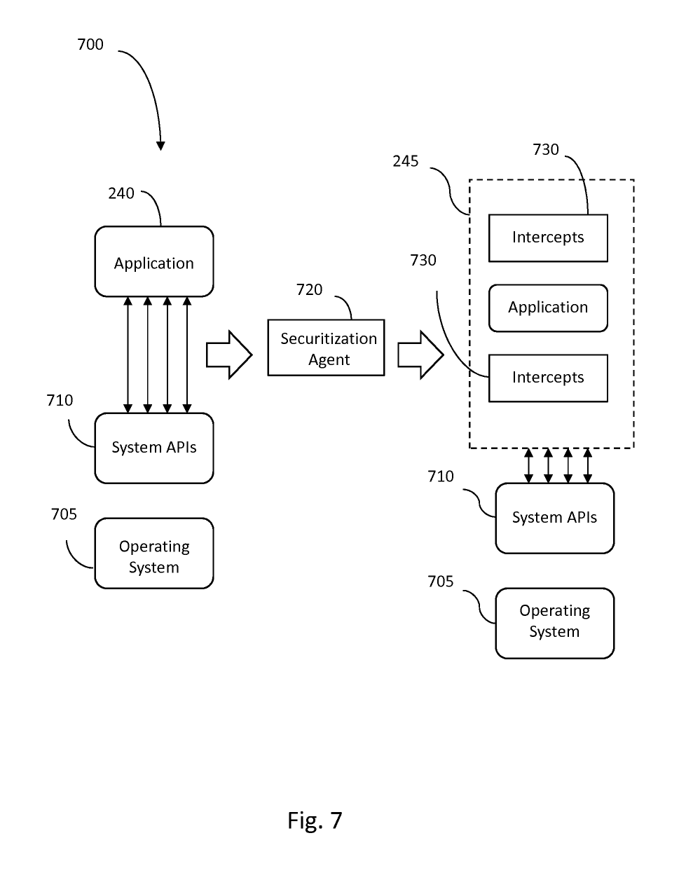

Recent advances have been realized in application configuration and management. In particular, applications may be modified to enable the applications to be managed in a certain way or to achieve new functionalities, a process commonly referred to as wrapping or securitizing an application. Referring to FIG. 7, an exemplary representation 700 of the wrapping or securitization process is illustrated. Here, a conventional or target application 240 is shown in which the target application 240 is developed for operating system 705 and calls system APIs 710. At this point, the target application 240 may be considered a non-secure application. The target application 240 can be submitted to a securitization agent 720, and the securitization agent 720 can subject the target application 240 to the wrapping process to generate a secure application 245. The securitization agent 720 can include any suitable number and type of software and hardware elements to carry out the securitization process.

In view of this procedure, the secure application 245 may still maintain its affiliation with the operating system 705 and may still call the system APIs 710. The overall utility of the secure application 245, however, is increased because one or more intercepts 730 may be interposed on the system APIs 710. These intercepts may be representative of any number of policies that are set forth by a party in control of the secure application 245 and of any new or modified functionalities that are realized from the wrapping process.

It is important to note that securitizing an application 240 does not just add a dynamic library to an executable by simply modifying the header of an executable, a process that is easily undone and may violate development agreements associated with the application; rather, it can repackage the application so that the injected code is physically inseparable from the original code. This method prevents secure applications that may be modified by third parties from running within a secure environment.

In addition, the wrapping or securitization process can preserve all the normal functions and APIs of a platform, while ensuring that protected information is handled securely. Application developers do not have to create applications or modify existing applications to accommodate this procedure and are not required to use any custom APIs or lose any functions associated with their applications. Calls to data sharing or data storage APIs may be automatically intercepted to ensure that sensitive enterprise data is handled appropriately. As such, secure applications may share data in the normal methods that are available on a given platform, but secure applications may not be able to share data with non-secure applications. It is also important to note that secure applications 245 can be created from virtually any type of target application 240, including those that are developed by different entities who sign their applications 240 with their own certificates. That is, applications 240 that are attached to certificates that are signed by different entities may undergo the wrapping process to become secure applications 245. These secure applications 245, as will be described later, may become part of a secure workspace, even though at least some of them may be unrelated. The secure applications 245 may be unrelated in that their certificates are signed by different entities, although other factors may deem whether secure applications 245 are unrelated, whether in addition to the certificates or in lieu of them. Any suitable party may sign the certificate of a secure application 245, including the party who developed the target application or the party who performed the securitization process.

There are several ways to carry out the process of securing applications. The first scheme primarily focuses on byte-code injection, in which byte-code API calls are replaced with intercepts. As an example, this method is particularly applicable to—but certainly not limited to—certain applications formatted for the Android operating system developed by Google, Inc. of Mountain View, Calif. The second scheme chiefly centers on linking in replacement calls for native object code. This latter method is useful for applications that use native methods, such as Android applications that rely on native code (i.e., they do not run under a virtual machine) and applications developed for iOS, a mobile operating system developed by Apple, Inc. of Cupertino, Calif. Of course, these are merely examples presented here, as other methods may be used to create the secure applications. Additional information on these concepts is presented in U.S. patent application Ser. No. 13/626,470, filed on Sep. 25, 2012, which is incorporated by reference herein in its entirety.

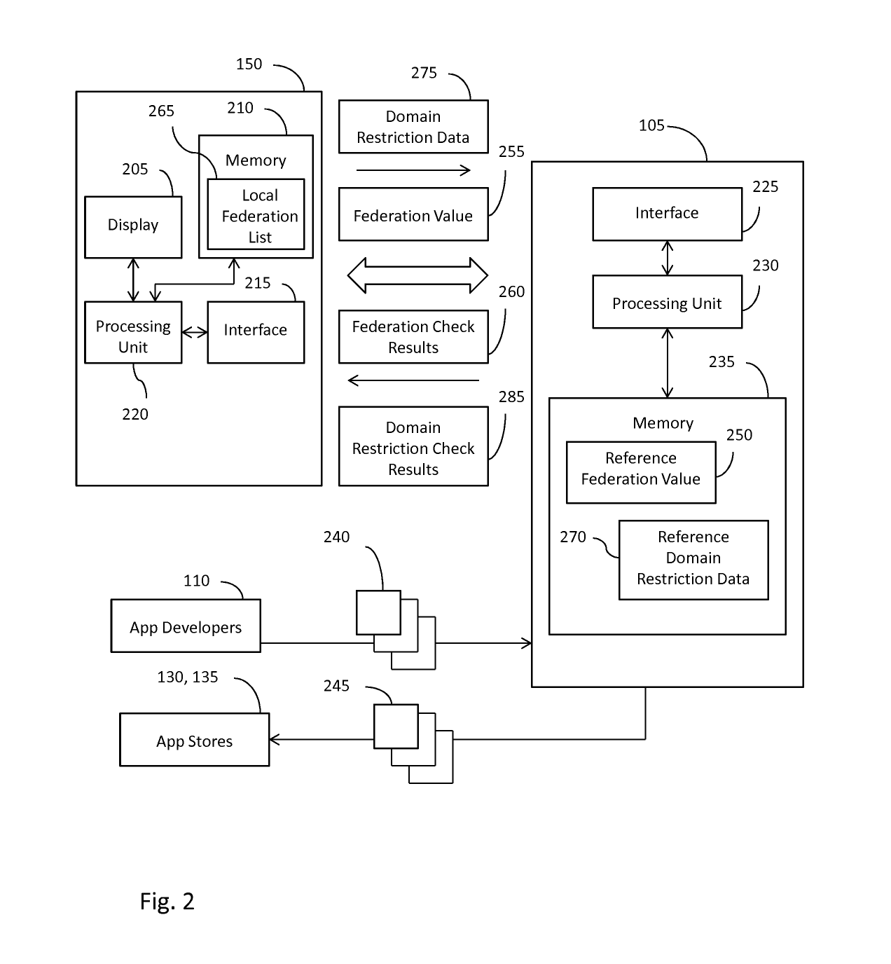

Referring to FIG. 2, certain parts of the system 100 of FIG. 1 are shown in additional detail. For example, a domain computing device 150 is illustrated in which the device 150 can include a display 205, memory 210, an interface 215 and a processing unit 220, which can be communicatively coupled to each of the components recited above. Briefly, the display 205 can be used to present various user interface (UI) elements and can facilitate the entry of commands through, for example, the use of a touch screen. Memory 210 can include both volatile and non-volatile types and can be used to store data to assist the processes that are described herein. The interface 215 can support any suitable type of communications, such as wireless, wired or a combination thereof, and can be used to enable data exchange with the administrative facility 105. A processing unit 220 can manage, execute, control and oversee the processes described herein, at least with respect to the computing device 150.

In one arrangement, the administrative facility 105 may include an interface 225—which can enable it to conduct communications with the computing device 150 and other components—and a processing unit 230. The facility 105 may also include memory 235, which can store various types of data related to computing devices and other information necessary to conduct the processes described herein. The processing unit 230 may be communicatively coupled to the interface 225 and the memory 235 and can manage, execute, control and oversee the processes associated with the facility 105.

As also shown here, the application developer portal 110 may direct unrelated target applications 240 to the administrative facility 105. The securitization agent 720 (see FIG. 7) may be integrated within the processing unit 230 (or some other suitable component), and the processing unit 230 can modify the unrelated target applications 240 to create unrelated secure applications 245 for possible installation in a secure workspace. In one arrangement, the administrative facility 105 (or some other facility or component) can cause the secure applications 245 to be published at the domain application stores 130, 135 or at some other location or to be delivered directly to the computing devices 150, 160 or to some other component.

As mentioned earlier, any number of applications may be converted to secure applications and offered for inclusion in a secure workspace, such as through the application stores 130, 135. Of course, non-secure applications may also be offered at the application stores 130, 135 or at other forums, which may be available to the computing devices 150, 160. These applications may also be attached to certificates that are signed by a large number of disparate parties, including applications that may attempt to join a secure workspace. An enterprise may also wish to keep any applications that it has customized for its domain from operating in an unauthorized domain. Likewise, the enterprise may also want to prevent unrecognized applications, such as those customized for other enterprises or those that have malicious code embedded in them, from joining their secure workspaces. To ensure the integrity of the computing devices 150, 160 and any sensitive data, certain steps may be taken to confirm the applications and proper domain isolation and operation.

In one embodiment, when a target application 240 is converted into a secure application 245, a reference federation value 250 can be generated and stored in the memory 235 of the administrative facility 105. As an example, the reference federation value 250 can be a value that may be used to authenticate the secure application 245 at a later time. When the secure application 245 attempts to, for example, join a secure workspace on the computing device 150 (or federate), the computing device 150 can generate a federation value 255 and can send it to the facility 105. It is important to note that the term federate may also encompass or apply to applications (secure or non-secure) joining a non-secure workspace. At the facility 105, a federation check can be conducted by comparing the generated federation value 255 to the reference federation value 250. The facility 105 can then send the federation check results 260 to the computing device 150. If the federation check is satisfied, the secure application 245 may be permitted to join the secure workspace. In another arrangement, a local federation list 265 may be updated to indicate to other authorized applications that the secure application 245 is approved for communications with other applications. If the federation check is not satisfied, the secure application 245 may not be permitted to join the secure workspace and it may be restricted from communicating with other applications.

In another arrangement, a domain restriction check may be conducted, such as a supplement to the federation check described above. For example, when the target application 240 is converted to the secure application 245, reference domain restriction data 270 associated with the secure application 245 may be determined and stored in the memory 235 of the administrative facility. As an example, the reference domain restriction data 270 can be used to determine whether a secure application 245 is or is about to operate in an authorized domain. In particular, when the secure application 245 attempts to join a secure workspace, the computing device 150 may send domain restriction data 275 to the administrative facility 105, which can conduct a domain restriction check. The facility 105 may then send the domain restriction check results 285 to the computing device 150. If the domain restriction check is satisfied, the secure application 245 may join the secure workspace. If not, the secure application 245 may not be permitted to do so.

As noted above, the domain restriction check may supplement the federation check of an application. Thus, even if an application passes the federation check, it may not be permitted to join a secure workspace if it does not also pass the domain restriction check. That is, an application may be required to pass both the federation check and the domain restriction check before being permitted to join a secure workspace. Of course, the domain restriction check may be conducted for an application without performing a federation check. In other words, an application may be allowed to join a secure workspace if it just passes the domain restriction check. It is also important to note that if both checks are to be conducted, they may be executed in any suitable order or sequence. Additional description of these processes will follow.

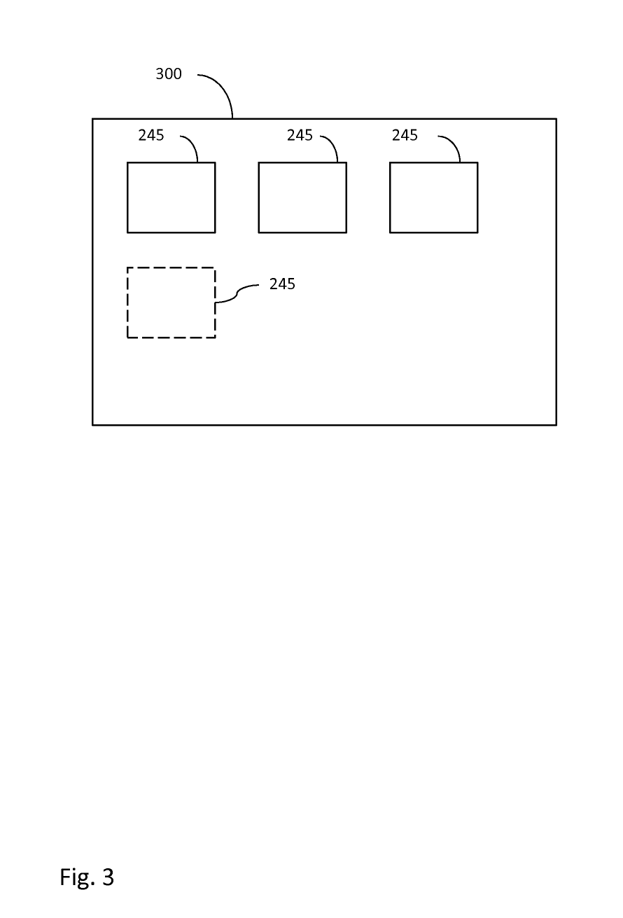

Referring to FIG. 3, a representation of an exemplary secure workspace 300 is shown. The secure workspace 300 may be part of the computing device 150 and can include any number of installed secure applications 245. These secure applications 245 may have different certificates in comparison to one another. One of the installed secure applications 245, which is represented by the dashed outline, may be referred to as a potentially installed secure application 245 or a candidate application. Specifically, the potentially installed secure application 245 may have been downloaded onto the computing device 150, but it may not yet have been authenticated, which means that it may not yet be permitted to join the secure workspace 300. Before being permitted to join the secure workspace 300, the potentially installed secure application 245 may have to undergo one or more of the checks described above and to be illustrated further below.

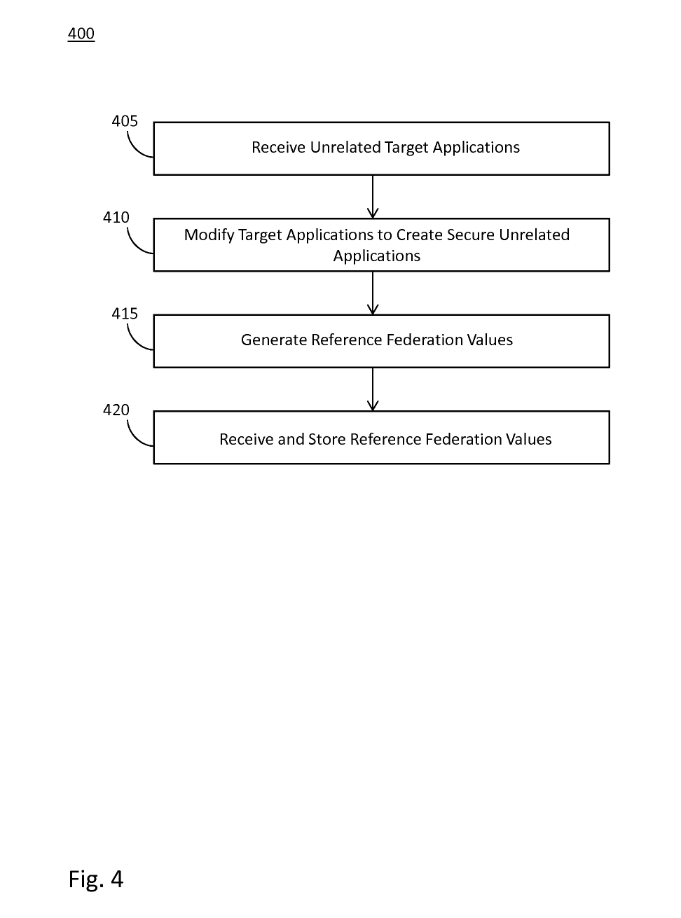

Referring to FIG. 4, a representative method 400 for creating secure applications through an adaption process is shown. To “adapt” an application means to convert an application to a secure application, as that term has been previously defined. It is important to note that the method 400 may include additional or even fewer steps or processes in comparison to what is illustrated in FIG. 4. Moreover, the method 400 is not necessarily limited to the chronological order that is shown in FIG. 4. In describing the method 400, reference may be made to other drawings in this specification, although it is understood that the method 400 may be practiced with any other suitable systems, components and user interface elements.

At step 405, unrelated target applications may be received, and at step 410, the target applications may be modified to create unrelated secure applications. At step 415, reference federation values can be generated, and the reference federation values can be received and stored, as shown at step 420.

For example, referring to FIG. 2 again, the application developer portal 110 can provide unrelated target applications 240 (having different certificates) to the administrative facility 105. The processing unit 230 at the facility 105 (or some other suitable component) can modify the target applications 240 through an adaption process—such as that described earlier—to create unrelated secure applications 245. As part of this adaption process, a reference federation value 250 may be generated for each or at least some of the secure applications 245. The term “reference federation value” is defined as a reference value that is used in a comparison procedure to determine whether an application is authentic. As an example, a reference federation value 250 may include a hash of any part of the secure application 245 and/or other identifying information. As a more specific example, the hash may be taken from at least some of the binary code of the application and information from a manifest or some other listing of data concerning the application. In one arrangement, at least some part of the hash should be based on a unique part of the code of the application, which can be useful for authentication purposes. This unique part may also be based on code that would likely or possibly be altered if the application was maliciously altered or hacked.

A contemporary (but non-limiting) example includes taking the hash of at least some of the binary from the classes.dex file and the package name and the version code (from the manifest.xml file) for Android applications. Another contemporary (but non-limiting) example includes taking the hash from at least a portion of the .ipa file and the bundle ID and version code (from info.plist file) of an iOS application. Any suitable type of a secure hash algorithm may be used for this purpose.

Once the reference federation value 250 is generated, it may be stored at any suitable location, such as the memory 235 of the administrative facility 105. Of course, the reference value 250 may be stored at other suitable locations, even the computing device 150 or another remote location, for later retrieval. In addition, the reference value 250 is not necessarily limited to being generated during the adaption process and does not have to be generated by the entity that performs the adaption of the application. As will be explained below, as part of the adaption process, the secure application 245 can be configured to generate installation federation values for comparison with the reference federation values 250 to determine whether the secure application 245 is permitted to be installed in the secure workspace 300.

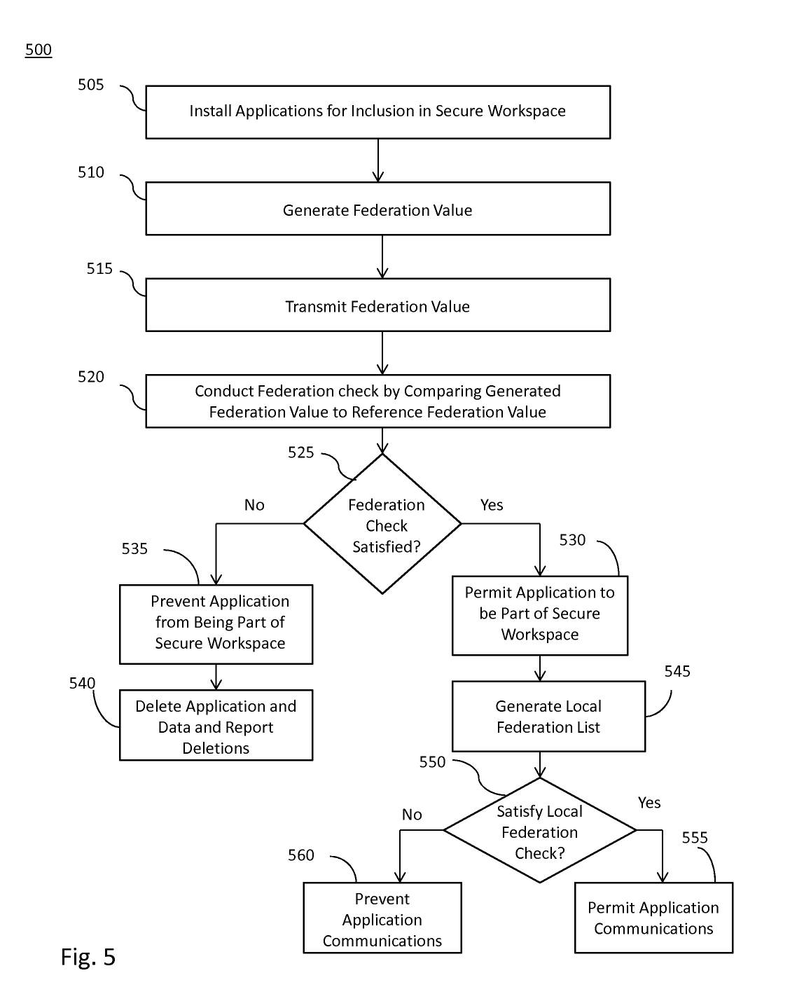

Referring to FIG. 5, a method 500 of enabling the federation of unrelated applications is shown. As previously referenced, the federation of an application is basically a process in which the application is permitted to join a secure workspace, although it may not necessarily be limited to a secure workspace. By joining the secure workspace, the application may have access to sensitive information and may be able to communicate or otherwise exchange data with other applications that are part of the workspace. It is important to note that the method 500 may include additional or even fewer steps or processes in comparison to what is illustrated in FIG. 5. Moreover, the method 500 is not necessarily limited to the chronological order that is shown in FIG. 5. In describing the method 500, reference may be made to the other drawings in this specification, although it is understood that the method 500 may be practiced with any other suitable systems, components and user interface elements.

At step 505, one or more applications may be installed for inclusion in a secure workspace, and corresponding federation values may be generated, as shown at step 510. At step 515, the generated federation values may be transmitted to an appropriate location or source, and federation checks may be conducted, such as by comparing the generated federation values to reference federation values, as shown at step 520. At decision block 525, it can be determined whether the federation check has been satisfied. If so, then the application may be permitted to be part of the secure workspace, as shown at step 530. A local federation list may also be generated, enhanced or updated in response, too, as shown at step 545. If the federation check is not satisfied, however, then the application may be prevented from being part of the secure workspace, as shown at step 535. Furthermore, at step 540, the application and any data related to the application may be deleted, and such deletion may be reported to an appropriate source.

Examples will now be presented. One or more applications, such as secure applications 245, may be downloaded to the computing device 150. For example, a user or an enterprise or some other organization may wish to have a secure application 245 as part of the secure workspace 300 for the computing device 150. As explained earlier, the secure application 245 may come from an application store (such as domain B application store 135) or from some other authorized source. In response, the processing unit 220 of the computing device 150 may generate a federation value 255 and can direct the interface 215 to transmit the generated federation value 255 to the administrative facility 105. The generation of the federation value 255 can occur when the secure application 245 is installed or at a later time, such as when it is launched (initially launched or otherwise). In addition, the generation of the federation value 255 can be similar to the process described in relation to the reference federation value 250, meaning the generated value 255 can be a hash of some portion of the secure application 245. It is also understood that some component other than the computing device 150 can generate the federation value 255.

In one arrangement, the administrative facility 105 can receive the generated federation value 255 and the processing unit 230 of the facility 105 can conduct a federation check by comparing the generated value 255 to the reference value 250. Of course, the federation check can be conducted at some other remote location or even locally at the computing device 150 (if the device 150 has or can get access to the reference value 250). As an example, the comparison between the generated value 255 and the reference value may require an exact match. If there is an exact match, then the federation check may be considered to be satisfied. If not, then the check may be considered to be not satisfied. Of course, an exact match may not necessarily be required. For example, differences in the generated value 255 and the reference value 250 may be based on insignificant or innocuous alterations that may be ignored. In fact, the level of matching required may even be considered dynamic, meaning that it may change based on certain modifications to the secure application 245 that were necessary but authorized. In either arrangement, the satisfaction of a federation check can be based on meeting some predefined threshold (with or without deviations) which may or may not change over time.

If the federation check is satisfied, in one embodiment, the administrative facility 105 (or some other suitable component) may send the federation check results 260 to the computing device 150. There may be one or more intermediary devices to facilitate this transmission. The federation check results 260 may include an explicit approval of the federation check that can instruct the computing device 150 to permit the secure application 245 to federate. As an alternative, the results 260 may contain information related to the comparison, and the computing device 150 may, based on its review of this information, determine whether to allow the secure application 245 to join the secure workspace 300.

If the federation check is not satisfied, the administrative facility 105 may notify the computing device 150, and the secure application 245 may not be permitted to join the secure workspace 300. Thus, if a secure application 245 has been breached through some unauthorized manner, the federation check may detect the intrusion, and the compromised application 245 may be prevented from harming the computing device 150 or other applications on the device. Additional steps may be taken in this scenario. For example, the application 245 and any data associated with it may be deleted from the computing device 150. Moreover, the computing device 150 may be locked or other data may be wiped, and the user and the application developer may be informed. The administrative facility 105 may instruct the computing device 150 to take these steps, or the device 150 may take such action on its own accord. In either arrangement, confirmation of this type of action may be reported back to the facility 105.

It is important to note that federation checks may not necessarily be imposed on all applications that are installed on the computing device 150, as the process may be selective in nature. For example, federation checks may only be conducted on secure applications 245 that are attempting to join the secure workspace 300. As another example, the federation checks may only be carried out against applications that are developed by or signed by a particular application developer or only against applications that are assigned to certain domains.

Referring back to the method 500 of FIG. 5, at step 545 and as noted earlier, a local federation list can be generated. At decision block 550, it can be determined whether a local federation check has been satisfied. If so, application communications may be permitted, as shown at step 555. If not, they may be prevented, as shown at step 560. Examples of these steps will be presented below.

In one arrangement, if the secure application 245 passes the federation check, a local federation list 265 can be generated (see FIG. 2). For purposes of this description, generating the local federation list 265 can include creating, updating or otherwise modifying the federation list 265. For example, identification information related to the secure application 245 that is permitted to join the secure workspace 300 can be added to the federation list 265. As a specific but non-limiting example, the package name and the version code of the authenticated secure application 245 may be added to the federation list 265, although certainly other identifying information related to the application 245 can be added to the federation list 265.

In view of unrelated secure applications 245 being part of a secure workspace 300, wherein cross-certificate communications may occur, other precautions may be taken to ensure that a particular application is authorized. One such precaution may be consulting the local federation list 265. For example, if a first secure application 245 receives a communication from a second secure application 245, the first application 245 can request the relevant identifying information from the second secure application 245, such as though calling an appropriate API and providing the UID of the second secure application 245. The identifying information associated with the second application 245 can then be provided to the first application 245, which can then consult the local federation list 265. If the first application 245 determines—via the local federation check—that the second application 245 is an authorized application, the communication exchange between the first and second applications 245 may occur. If the local federation check fails, however, the communication request from the second application 245 may be denied.

Other ways to conduct communications in this type of environment may be realized. For example, in one case, a file system may be imposed on a memory element of the computing device 150, such as a paste memory element (not shown). The secure applications 245 may conduct communications with one another using the file system imposed on the paste memory element. The data stored in the paste memory element may be encrypted, and only authorized applications 245 may have access to this data, such as through the sharing of any appropriate keys. This process may apply in a secure workspace that includes unrelated secure applications, although it is certainly not so limited. Additional information on this arrangement is presented in U.S. patent application Ser. No. 13/942,042, filed on Jul. 15, 2013, which is incorporated by reference herein in its entirety.

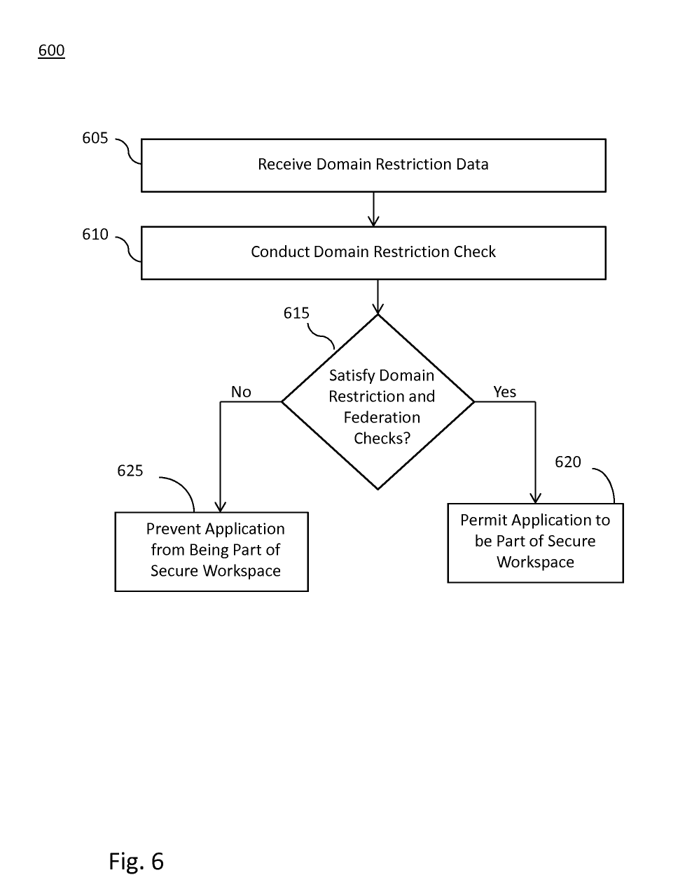

In addition to the federation check described above, other steps may be taken to protect secure workspaces and enterprise data. As an example, referring to FIG. 6, a method 600 of an exemplary check that may supplement the federation check is illustrated. It is important to note that the method 600 may include additional or even fewer steps or processes in comparison to what is illustrated in FIG. 6. Moreover, the method 600 is not necessarily limited to the chronological order that is shown in FIG. 6. In describing the method 600, reference may be made to the other drawings in this specification, although it is understood that the method 600 may be practiced with any other suitable systems, components and user interface elements.

At step 605, domain restriction data may be received, and a domain restriction check may be conducted at step 610. At decision block 615, it can be determined whether a domain restriction check and a federation check have been satisfied. If so, at step 620, the application may be permitted to be part of a secure workspace. If not, at step 625, the application can be prevented from being part of the secure workspace. Several examples will now be presented.

In one embodiment, reference domain restriction data 270 associated with a secure application 245 may be obtained. For example, when a target application 240 is converted into a secure application 245, the administrative facility 105 may receive information that is related to the domain to which the secure application 245 belongs and store in the memory 235 the information as the reference domain restriction data 270. As an example, when a secure application 245 (or a conventional application) is created, it may be attached to or restricted to a particular domain. For example, referring to FIG. 1, assume that an enterprise has developed a customized secure application 245 and wishes to publish the application 245 to domains B 120, 140, 145. Information related to the domains B 120, 140 and 145 may be recorded as the reference domain restriction data 270, meaning that the secure application 245 may be limited to operation in these domains. Examples of such information include an enterprise identifier, code related to the relevant domains and a tenant identifier. Although the reference domain restriction data 270 may be obtained when the secure application 245 is created, such information can be received at other suitable times, like when the secure application 245 is made available in an application store. In addition, if the enterprise wants to expand the reach of the secure application 245, it can supplement the reference domain restriction data 270 to account for any new domains. In contrast, if the enterprise wants to keep the publication of a particular application from previously-approved domains, the enterprise can supplement the reference domain restriction data 270 by removing the information related to any such domains.

Similar to the discussion above relating to the generated federation value 255, when the secure application 245 attempts to join the secure workspace 300, the processing unit 220 of the computing device 150 (or some other appropriate component or facility) can generate domain restriction data 275. The term “generate” as used herein means to produce, obtain, reproduce or otherwise come into possession of. The generation of the domain restriction data may occur when the secure application 245 is installed on the computing device 150, when it is launched or at any other suitable time. Moreover, the domain restriction data 275 can be generated before, after or even at the same time as the generated federation value 255. As an example, the generated domain restriction data 275 may include information related to the computing device 150 and the domain in which it is operating. As a specific but non-limiting example, the device information can include the MDI key of the computing device 150 and the URL related to the domain in which the device 150 is currently operating. Of course, other types of information may be generated and provided to serve as the generated domain restriction data 275 for comparison to the reference domain restriction data 270.

Once the administrative facility 105 receives the generated domain restriction data 275, the processing unit 230 can conduct a domain restriction check, such as by comparing the generated domain restriction data 275 with the reference domain restriction data 270. If the domain restriction check is used as a supplement to the federation check, then the generated federation value 255 can be used to help identify the particular application that is attempting to federate. For example, if a user of a computing device 160 that is attached to domain B 120 receives a secure application 245, and the secure application 245 attempts to join a secure workspace 300 of the computing device 160, the device 160 can provide the generated domain restriction data 275, which may include a device identifier associated with the device 160 and information related to the domain in which the device 160 is currently operating. The administrative facility 105 (or some other suitable facility or component) may compare the generated domain restriction data 275 with the reference domain restriction data 270. As part of this process, the facility 105 may also rely on the generated federation value 255 to identify the secure application 245. As such, the facility 105 may be aware of the identity of the secure application 245, the device 160 and the domain in which the device 160 is operating, which can enable it to perform the domain restriction check.

Similar to the federation check, the domain restriction check may require an exact match between the reference domain restriction data 270 and the generated domain restriction data 275. If there is an exact match, then the domain restriction check may be considered to be satisfied. If not, then the check may be considered to be not satisfied. Of course, an exact match may not necessarily be required, and the level of matching required may even be considered dynamic. The satisfaction of a domain restriction check can be based on meeting some predefined threshold (with or without deviations) which may or may not change over time. As noted earlier, the reference domain restriction data 270 may be amended to account for changes to any domain enforcement.

If the domain check is satisfied, the administrative facility 105 can provide domain restriction check results 285 to the computing device 150. As an example, the domain restriction check results 285 may be explicit approvals or information related to the comparison, thereby permitting the device 150 to determine whether the domain check is satisfied. If the domain restriction check merely supplements the federation check, then the secure application 245 may be permitted to join the secure workspace 300 if both the domain restriction check and the federation check are satisfied. If the domain restriction check is not satisfied, then the secure application 245 may not be permitted to join the secure workspace 300, even if the secure application 245 passes the federation check. This may prevent applications 245, even those that have not been compromised, from operating in unauthorized domains.

In one arrangement, the domain restriction check may be carried out without the use of federation checks. That is, an enterprise may not wish to conduct federation checks on applications, including secure applications 245 that may be attempting to join the secure workspace 300. In this instance, the domain restriction check results may be the overriding factor in determining whether an application may be permitted to federate. That is, if the domain restriction check is satisfied, then the application may be allowed to join the secure workspace 300. If not, the application may not be permitted to do so. In addition, in this instance, an enterprise may decide to supplement the domain restriction check with the federation check, as described above. The supplementary federation check may apply to all domains and all applications attempting to federate, or it may be selectively applied.

If no federation check is to be performed, then the reference domain restriction data 270 may also include some indication as to the identity of the application. In this case, the generated domain restriction data 275 may also include information related to the identity of the application attempting to federate. Examples of information related to the identity of the application for the reference domain restriction data 270 and the generated domain restriction data 275 include the bundle ID, the package name and the version code, although other types of data may be used here.

Like the federation checks described above, the domain restriction checks may not necessarily be conducted against all applications or computing devices of a domain. For example, the domain restriction check may be limited to only secure applications 245 trying to federate or may be selectively applied to domains, such that only domains related to a particular enterprise or group are subjected to the check. In addition, the number of devices and the domains subject to the domain restriction check may be dynamic in nature, meaning that domain enforcement may take into account, for example, changes to an organization's structure or policies.

In addition to federation and domain restriction checks, other processes may be used to protect the integrity of an enterprise's ecosystem. For example, a signature check may be conducted, which can compare the current signature associated with an application trying to federate with a reference signature that was present when the application was developed or adapted. If there is a match, then the federation may be permitted. If not, then the application may be barred from doing so.

Although a significant portion of this description focuses on secure applications and secure workspaces, it is understood that the principles herein are not so limited. These concepts may be applied to any suitable application and workspace, secure or otherwise. Moreover, the applications herein are not necessarily limited to applications having different certificates, meaning that all the applications in a workspace may be signed by the same entity and the features herein may be applied to them.

While various embodiments have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

What is claimed is:

1. A method of enabling the federation of unrelated applications, comprising:
installing a candidate application for inclusion in a secure workspace, wherein a first previously-installed application in the secure workspace has a certificate signed by a first entity and a second previously-installed application in the secure workspace has a certificate signed by a second entity such that the first and second previously-installed applications have different certificates;
generating a federation value for the candidate application;
determining the result of a federation check of the candidate application based on the generated federation value; and
if the federation check is satisfied, permitting the candidate application to be part of the secure workspace.

2. The method according to claim 1, further comprising preventing the candidate application from being part of the secure workspace if the federation check for the candidate application is not satisfied.

3. The method according to claim 2, wherein preventing the candidate application from being part of the secure workspace comprises deleting the candidate application, deleting any data associated with or generated by the candidate application and reporting such deletions to a remote location.

4. The method according to claim 1, further comprising transmitting the federation value to a remote location to enable the federation check to be performed at the remote location.

5. The method according to claim 1, further comprising comparing the generated federation value to a known federation value as part of the federation check.

6. The method according to claim 5, wherein comparing the generated federation value to the known federation value is performed locally.

7. The method according to claim 1, wherein the federation value is a hash based on at least some of the code of the candidate application.

8. The method according to claim 7, wherein the hash is further based on an identification name and version code of the candidate application.

9. The method according to claim 1, wherein generating the federation value further comprises generating the federation value at the time when a candidate application is installed or when the candidate application is launched.

10. The method according to claim 1, further comprising determining the result of a domain restriction check of the candidate application and permitting the candidate application to be part of the secure workspace if both the federation check and the domain restriction check of the candidate application are satisfied.

11. The method according to claim 10, further comprising sending a device identification to a remote location to facilitate the domain restriction check.

12. The method according to claim 1, further comprising generating a local federation list that includes information related to applications that have satisfied the federation check and have been permitted to be part of the secure workspace.

13. The method according to claim 12, permitting communications between applications with different certificates if one or more of the applications satisfy a check with the local federation list.

14. A method of enabling the federation of unrelated applications, comprising:
receiving a reference federation value associated with an application;
storing the reference federation value;
when the application is installed on a computing device or some time after the installation of the application on the computing device, receiving a generated federation value from the computing device;
conducting a federation check that at least includes comparing the generated federation value to the reference federation value; and
generating a federation approval signal to be delivered to the computing device that authorizes the application to be part of a secure workspace on the computing device if the federation check is satisfied.

15. The method according to claim 14, further comprising generating a federation disapproval signal to be delivered to the computing device that prevents the application from being part of the secure workspace on the computing device if the federation check is not satisfied.

16. The method according to claim 15, further comprising receiving a notification that the application was removed from the computing device in response to the receipt of the federation disapproval signal at the computing device.

17. The method according to claim 14, wherein the reference federation value and the generated federation value are hash values based on at least some portion of the application.

18. The method according to claim 17, further comprising:
receiving a device identification from the computing device; and
conducting a domain restriction check to determine whether the application is permitted to operate in the domain of the computing device.

19. The method according to claim 18, further comprising:
generating a domain restriction approval signal if the domain restriction check is satisfied; or
generating a domain restriction disapproval signal if the domain restriction check is not satisfied.

20. The method according to claim 19, further comprising generating the domain restriction disapproval signal if the domain restriction check is not satisfied even if the federation check of the application is satisfied.

21. A method of enabling the federation of unrelated applications, comprising:
receiving at a remote location reference federation values associated with a plurality of applications having different certificates;
storing the reference federation values at the remote location;
installing at least one of the applications on a computing device;
generating a federation value for the installed application;
transmitting the generated federation value to the remote location;
performing a federation check at the remote location by comparing the generated federation value to the reference federation value that is associated with the installed application;
if the federation check is satisfied, generating a federation approval signal to be delivered to the computing device; and
in response to the receipt of the federation approval signal, permitting the installed application to be part of a secure workspace of the computing device.

22. The method according to claim 21, wherein if the federation check is not satisfied:
generating a federation disapproval signal to be delivered to the computing device;
in response to the receipt of the federation disapproval signal, preventing the application from being part of the secure workspace of the computing device.

23. The method according to claim 22, wherein preventing the application from being part of the secure workspace comprises deleting the application, deleting any data associated with or generated by the application and reporting the deletion to the remote location.

24. The method according to claim 21, wherein the reference federation values and the generated federation value are hashes based on at least part of the executable code of the applications.

25. The method according to claim 21, further comprising performing a domain restriction check at the remote location to determine whether the installed application is in an authorized domain.

26. The method according to claim 25, further comprising:
generating a domain restriction approval signal if the domain restriction check is satisfied such that the installed application is in an authorized domain; or
generating a domain restriction disapproval signal if the domain restriction check is not satisfied such that the installed application is outside an authorized domain.

27. A method of enabling the federation of unrelated applications, comprising:
receiving unrelated target applications, wherein the unrelated target applications are attached to certificates that are signed by different entities;
modifying the unrelated target applications to create secure unrelated applications for possible installation in a secure workspace; and
generating reference federation values for the unrelated secure applications;
wherein modifying the unrelated target applications includes configuring the unrelated secure applications to generate installation federation values for comparison with the reference federation values to determine whether the unrelated secure applications are permitted to be installed in the secure workspace.

28. The method according to claim 27, wherein the reference federation values and the installation federation values are hashes that are based on at least a portion of the unrelated secure applications.

29. The method according to 28, wherein the hashes are also based on identifications and version codes of the unrelated secure applications.

30. The method according to claim 27, wherein modifying the unrelated target applications further includes configuring the unrelated secure applications to generate the installation federation values at the time the unrelated secure applications are installed on a computing device or at the time the unrelated secure applications are launched on the computing device.

31. The method according to claim 27, wherein modifying the unrelated target applications further includes configuring the unrelated secure applications to provide domain restriction information for the purpose of determining whether the unrelated secure applications are part of an authorized domain.

32. A computing device, comprising:
a display that is configured to display a plurality of installed applications that are part of a secure workspace;
memory that is configured to store the installed applications; and
a processing unit that is communicatively coupled to the display and the memory, wherein the processing unit is configured to:
direct the installation of the applications, wherein the applications are unrelated applications such that at least some of the applications have certificates that are signed by different entities;
generate a federation value for an application that is to be part of the secure workspace;
determine the result of a federation check of the application based on the generated federation value; and
permit the application to be part of the secure workspace if the federation check is satisfied.

33. The computing device according to claim 32, wherein the processing unit is further configured to prevent the application from being part of the secure workspace if the federation check is not satisfied.

34. The computing device according to claim 32, further comprising an interface that is communicatively coupled to the processing unit and that is configured to transmit the generated federation value to a remote location, where the generated federation value is compared to a reference federation value.

35. The computing device according to claim 32, wherein the processing unit is further configured to generate the federation value at the time the application is installed or at the time the application is launched.

36. The computing device according to claim 32, wherein the application is a secure application that has been modified by binding one or more intercepts into the application.

37. The computing device according to claim 32, wherein the processing unit is further configured to:
determine the result of a domain restriction check of the application that is to be part of the secure workspace; and
permit the application to be part of the secure workspace if both the federation and domain restriction checks are satisfied.

38. The computing device according to claim 32, wherein the processing unit is further configured to generate a local federation list that identifies the applications that have been permitted to be part of the secure workspace.

39. The computing device according to claim 38, wherein the processing unit is further configured to facilitate communications between unrelated applications that are part of the secure workspace if one or more of the unrelated applications satisfy a check of the local federation list.

40. An administrative facility, comprising:
an interface that is configured to facilitate communication exchanges with a plurality of computing devices;
memory for storing information related to the computing devices; and
a processing unit that is communicatively coupled to the interface and the memory, wherein the processing unit is configured to:
receive from the interface a reference federation value of an application;
store the reference federation value into the memory;
receive from the interface a generated federation value of the application when the application is attempting to federate in a secure workspace of a computing device;
conduct a federation check by comparing the generated federation value to the stored reference federation value; and
generate a federation approval signal to be delivered to the computing device that authorizes the application to be part of the secure workspace if the federation check is satisfied.

41. The administrative facility according to claim 40, wherein the federation check is satisfied if the generated federation value matches the reference federation value.

42. The administrative facility according to claim 40, wherein the reference federation value and the generated federation value are hashes based on at least a portion of the application.

43. The administrative facility according to claim 40, wherein the application is a secure application.

44. The administrative facility according to claim 40, wherein the processing unit is further configured to conduct a domain restriction check to determine whether the application is permitted to operate in the domain of the computing device.

45. The administrative facility according to claim 40, wherein if the domain restriction check is not satisfied, the processing unit is further configured to generate a domain restriction disapproval signal that is designed to prevent the application from becoming part of the secure workspace, even if the federation check is satisfied.

46. An administrative facility for facilitating the federation of unrelated applications, comprising:
an interface that is configured to receive unrelated target applications, wherein the unrelated target applications are attached to certificates that are signed by different entities; and
a processing unit that is communicatively coupled to the interface, wherein the processing unit is configured to:
modify the unrelated target applications to create secure unrelated applications for possible installation in a secure workspace; and
generate reference federation values for the unrelated secure applications;
wherein modifying the unrelated target applications includes configuring the unrelated secure applications to generate installation federation values for comparison with the reference federation values to determine whether the unrelated secure applications are permitted to be installed in the secure workspace.

47. The administrative facility according to claim 46, wherein the interface is further configured to transmit the reference federation values to a remote location for storage.
